(19) United States
(12) Patent Application Publication
(10) Pub. No.: US 2009/0015761 A1
(43) Pub. Date: Jan. 15, 2009

(54) Combination transparent touch panel liquid crystal display stack and methods of manufacturing same

(75) Inventor: David H. Stockham, Spokane Valley, WA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Itronix Corporation, Spokane Valley, WA (US)

(21) Appl. No.: 11/797,623

(22) Filed: May 4, 2007

(51) Int. Cl. G02F 1/1335; G02F 1/13

(52) U.S. Cl. 349/96; 349/187

(57) ABSTRACT

A method of manufacturing an integrated transparent touch panel liquid crystal display device. A liquid crystal display component is made by forming a polarizing film an on underside and a quarter wave plate on an upper side, with the top polarizer removed. A transparent touch panel component is made by forming a pair of facing transparent electrodes on respective transparent substrates. A quarter wave plate is formed above the upper substrate, along with a second polarizer and antireflective layer in that order. The transparent touch panel is placed above the liquid crystal display component to form an integrated device. Improved daylight readability is achieved without increasing luminance or power consumption.

### FIELD OF THE INVENTION

The present invention relates generally to display device and more particularly to integrated transparent touch panel liquid crystal display devices and methods of manufacturing integrated transparent touch panel liquid crystal display devices having improved brightness and contrast properties.

### BACKGROUND OF THE INVENTION

In mobile computing applications, such as laptops, handhelds, and other portables, system robustness is usually constrained by power limitations. Because these devices may not be connected to line power, performance must be balanced against life. These types of devices often employ power management schemes such as automatically reducing system brightness when line power is disconnected. This reduction in performance may be acceptable in certain applications, such as inside a residence, on an airplane, or in other indoor application.

In outdoor applications, where direct sunlight may be incident upon the screen, display screen reflectance and brightness levels that work for indoor use may deliver unacceptably low contrast ratios. Contrast ratios are a good measure of image readability, i.e., higher values are generally better. Thus, despite operating at maximum power consumption, currently available brightness levels may still fails to provide satisfactory daylight performance.

Also, in display devices utilizing resistive integrated transparent touch panels, the problem of readability is even more acute because the touch panel introduces significant light loss as well as increased reflectance. Increasing the brightness level of the display to make it readable in these conditions will increase the rate at which power is consumed, increasing heat generated by the display and reducing battery operating life. Even at maximum brightness levels, displays on these devices may be difficult to read in bright ambient light environments. Accordingly, there is a need for an integrated display solution that ameliorates or overcomes some or all of the shortcomings of conventional displays.

### SUMMARY OF THE INVENTION

In view of the foregoing, various embodiments of the invention may provide a display device. The display device according to these embodiments may comprise a touch panel display comprising a lower transparent electrode formed on a first transparent layer, an upper transparent electrode formed on a second transparent layer, the upper and lower transparent electrodes facing each other with a space in between, a first one quarter wavelength film formed on a top surface of the second transparent layer, a first single linear polarizing film on the first one quarter wavelength layer, and an antireflective layer on the single polarizer layer, and a liquid crystal apparatus comprising a second single linear polarizing film, a liquid crystal cell on the second single linear polarizing film, and a second one quarter wavelength layer formed directly on the top surface of the liquid crystal cell, wherein the touch panel display is mounted on the liquid crystal apparatus to form an integrated display device, and the liquid crystal apparatus is characterized in that it does not contain a polarizer on a light emitting side of the liquid crystal cell.

At least one other embodiment of the invention may provide a method of manufacturing an integrated transparent touch panel liquid crystal display device. The method according to this embodiment may comprise forming a liquid crystal display apparatus comprising a liquid crystal cell having a first polarizing film mounted on a lower surface, and a first one quarter wavelength sheet mounted on an upper surface thereof, forming a transparent touch panel comprising forming a lower transparent electrode on an upper surface of a lower glass substrate, forming an upper transparent electrode on a lower surface of an upper glass substrate, forming a second one quarter wavelength film on an upper surface of the upper glass substrate, forming a single polarizing film on the one quarter wavelength sheet, forming an antireflective layer on the single polarizing film, and joining the liquid crystal display apparatus with the transparent touch panel to form an integrated device so that the first one quarter wavelength sheet of the liquid crystal display device faces the lower glass layer of the transparent touch panel.

Yet another embodiment according to this invention may comprise a method of manufacturing a combination touch panel liquid crystal display device having enhanced brightness and contrast. The method according to this embodiment may comprise forming a liquid crystal display apparatus by forming a first polarizing film on a bottom side a liquid crystal cell, removing a front polarizing film from a top side of the liquid crystal cell, and forming a first one quarter wavelength sheet on the top side of the liquid crystal cell, forming a transparent touch panel apparatus by forming a first transparent electrode on a top surface of a lower substrate, forming a second transparent electrode on a bottom surface of an upper substrate, positioning the second transparent electrode over the first transparent electrode with a space in between, forming a second one quarter wavelength sheet on a top surface of the upper substrate, forming a second single linear polarizing film on the second one quarter wavelength sheet, and forming an antireflective layer on the second single linear polarizing film, and joining the liquid crystal display device to the transparent touch panel apparatus to produce an integrated device such that the first one quarter wavelength sheet faces a bottom surface of the lower substrate.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 is a block diagram of an integrated transparent touch panel liquid crystal display stack.

FIG. 2 is an exploded view of an integrated transparent touch panel display stack illustrating the brightness reduction of the source light as it passes through the LCD and TTP components.

FIG. 3 is a block diagram of a conventional integrated transparent touch panel liquid crystal display stack.

FIG. 4 is a block diagram of an integrated transparent touch panel liquid crystal display apparatus according to at least one embodiment of the disclosure.

FIG. 5 is a block diagram illustrating internal reflectance in an conventional integrated transparent touch panel liquid crystal display apparatus.

FIG. 6 is a block diagram illustrating internal reflectance in an integrated transparent touch panel liquid crystal display apparatus according to at least one embodiment of the disclosure.

FIG. 7 is a flow chart of an exemplary method of manufacturing an integrated transparent touch panel liquid crystal display device according to at least one embodiment of the invention.

FIG. 8 is a block diagram of an integrated transparent touch panel liquid crystal display apparatus according to at least one other embodiment of the disclosure.

FIG. 9 is a block diagram of an integrated transparent touch panel liquid crystal display apparatus according to at least one additional embodiment of the disclosure.

FIG. 10 is a block diagram of a liquid crystal display apparatus according to at least one embodiment of the disclosure.

### DETAILED DESCRIPTION OF THE DISCLOSURE

The following description is intended to convey a thorough understanding of the embodiments described by providing a number of specific embodiments and details involving integrated transparent touch panel liquid crystal display devices and methods of manufacturing such devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

As used herein, the term “forming” will be interpreted broadly to refer to manufacturing, placing, attaching, a layer, film or other component, either as an equipment manufacturer or equipment assembler and may involve any number of manual and/or automated steps and even combinations of manual and automated steps.

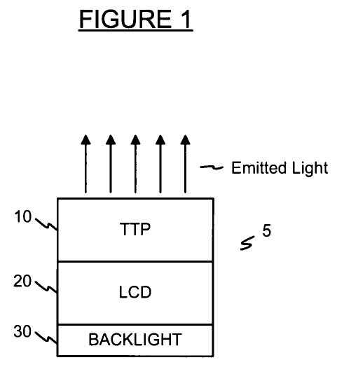

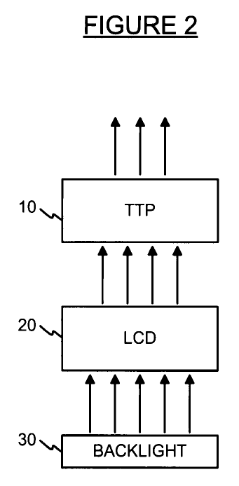

Referring now to FIG. 1, this Figure illustrates a block diagram of an integrated transparent touch panel liquid crystal display stack. The integrated stack 5 comprises a transparent touch panel display (TTP) 10, an liquid crystal device 20, such as an liquid crystal display (LCD) the configuration of which is well known in the art, and a backlight 30 that causes the image generated on the liquid crystal device 20 to be visibly displayed. Such an integrated device 5 may be used in an point-of-sale terminal, portable computer, automated teller machine, gaming system, or other application. Due to its relative transparency, in most applications, the TTP 10 may be oriented over the LCD 20 with a tolerable level of degradation of the image output by the LCD 20. However, in applications that require daylight/direct sunlight readability, image degradation caused by a TTP luminance loss and reflection may render the performance unacceptable, as is illustrated in the example of FIG. 2.

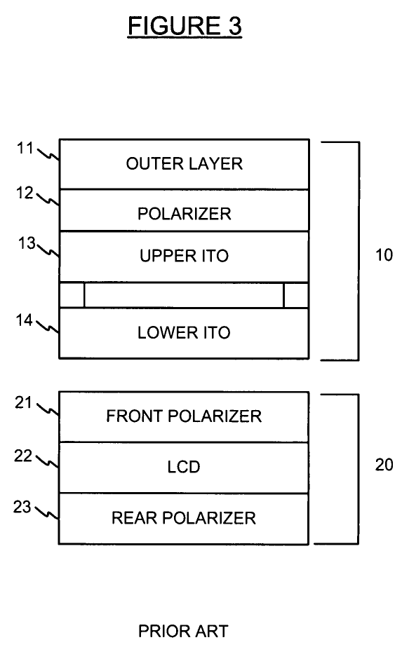

FIG. 2 is an exploded view of an integrated transparent touch panel display stack illustrating the brightness reduction of the source light as it passes through the LCD and TTP components and reflection effects. Light emitted by the display originates at the backlight source. The light source 30 may comprise one or more lamps, as is known in the art. Light emitted by the source 30 enters and subsequently exits the LCD 20. As is seen in the Figure, the amount of light exiting the LCD 20 is less than the amount that is incident on the underside. This will be explained in greater detail in the context of FIG. 3. Also, as seen in FIG. 2, the amount of light exiting the TTP 10, that is the visible light emitted by the device, is also less than the light incident on the back side of the TTP 10.

FIG. 3 is a block diagram of a conventional integrated transparent touch panel liquid crystal display stack. As is seen in FIG. 3, the LCD 20 of the conventional stack usually includes a rear polarizer 23, a liquid crystal cell 22, and a front polarizer 21. The TTP 10 commonly includes a pair of lower and upper transparent electrodes 14, 13 separated by a space. The TTP 10 may include a polarizing layer 12 above or on the upper transparent electrode 13 to reduce specular reflection resulting from refractive index mismatch attributed to materials utilized in resistive TTPs. The TTP 10 also usually includes one or more outer layers 11. The outer layers 11 may include additional polarizers, protective films, antireflective films, etc. Typically, in an integrated device, when the LCD 20 and TTP are joined, an air gap or space is maintained in between them. A reason for this is to prevent image degradation through cell-gap compression when the TTP 10 is depressed.

The reason that the LCD 22 includes a front polarizer 21 is that without the front polarizer 21 the LCD image (light) emitted by the LCD as a result of the backlighting, would not be visible. As is known in the art, in an LCD, the rear polarizer 23, linearly polarizes light from the backlight 30, absorbing one polarization axis. The LC material 22 facilitates displacement of the unitary axis of polarization delivered by the polarizer 23. When a voltage is applied to the transparent electrodes of the liquid crystal cell, a torque acts on the helical liquid crystal molecules, causing this helix to be modified and thus modulating the polarization angle of transmitted light. Light that has polarization modulation will be translated to luminance modulation in the front polarizer 21, because only light with a corresponding polarization angle will be maximally transmitted through the polarizer 21. By controlling the voltage applied across the liquid crystal layer in each pixel, light can be allowed to pass through in varying amounts, illuminating the pixel to a corresponding level between maximum and minimum in a grayscale display. Thus, if the front polarizer 21 is removed or not installed, the LCD 20 will be rendered unusable by itself because the human eye is insensitive to linear polarization modulation.

The front polarizer 21 is commonly included because the LCD 20 may be used in one of a variety of different applications, that it may be mated with a TTP, such as TTP 10, or it may be used stand alone, that is, in an electronic device having a simple display function without a TTP. A consequence of the front polarizer 21, is that the maximum amount of light transmitted by the LCD 22, is reduced.

Optical path losses may be compensated by increasing the luminance of the display. For example, LCD performance (luminance) is often characterized in the unit of nits. While most displays have luminances of 50 to 500 nits, high performance displays may have luminances of 1000 nits or more. This solution is costly in that the light source used to generate these luminance levels generates considerable heat, in extremis, causing degradation of LCD components. Also, brighter light sources consume more power which is fatal for battery powered portable display equipment. Finally, the inventor of this invention has discovered that in bright ambient light environments, high luminance displays may achieve worse contrast ratios and therefore degraded viewability compared to the integrated display device according to the various embodiments of this invention, which enhances transmittance and reduces reflection through novel design of the display stack.

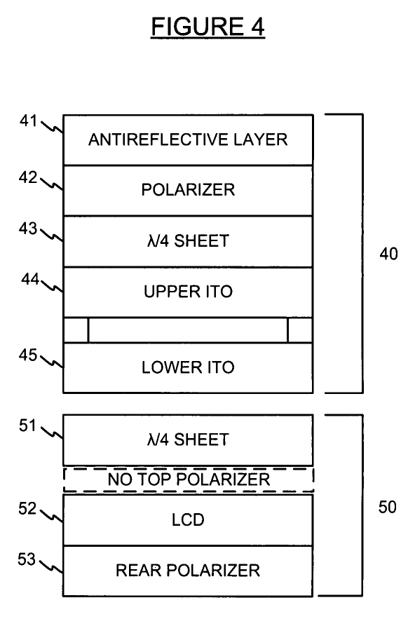

Referring now to FIG. 4, this Figure is a block diagram of an integrated transparent touch panel liquid crystal display apparatus according to at least one embodiment of this disclosure. The display stack includes a modified resistive transparent touch panel (TTP) 40 and a liquid crystal apparatus (50). The transparent touch panel 40 comprises an outer facing anti reflective layer 41. In various embodiments, this may comprise a layer made of Polyethylene terephthalate (PET) or similar material to reduce and ideally minimize diffuse and specular reflections. PET is advantageous because it is lightweight, colorless, transparent and deformable. The transparent touch panel also comprises a polarizer 42. In various embodiments, this may comprise a linearly polarizing film. The TTP 40 also comprises a quarter wave plate/sheet 43. Together, the polarizer 42 and quarter wave plate 43 combine to form a circular polarizer. This circular polarizing function may be formed in separate layers or as part of an integrated two layer polarizing film. The circular polarizer function 42/43, has properties that cancel specular reflections originating from refractive index mismatches that occur behind it and internal to the TTP 40.

The resistive TTP 40 includes standard upper transparent electrode 44 and a lower transparent electrode 45, typically separated by spacers so that depress on the front surface of the TTP 40 causes the upper electrode 44 to contact the lower electrode 45. The upper and lower transparent electrodes 44, 45 typically comprise a layer of semi-transparent indium tin oxide (ITO). As is known in the art, ITO is a popular choice for TTPs because of its combination of electrical conductivity and optical transparency. Both the upper and lower transparent electrodes 44, 45 may be mounted on glass, plastic, resin, or other suitable substrate layers, as in known in the art. ITO has a high refractive index, typically resulting in specular reflection levels of about 20% from two surfaces with an air interface.

The liquid crystal device 50 according to various embodiments of the invention comprises a liquid crystal cell 52. The liquid crystal cell 52 may comprise a liquid crystal material suspended between transparent electrodes as is commonplace in the art. The rear polarizer 53 linearly polarizes light entering the liquid crystal cell 52 which modulates the plane of polarization for light transmitted through it. The liquid crystal device 50 also comprises a one quarter wave sheet located on a top surface thereof. This sheet 51, is formed on the liquid crystal cell 50 at a location commonly allotted to the front linear polarizing layer of a typical LCD device. The inventor of this invention has discovered that by placing the second quarter wave plate 51 directly on the liquid crystal cell 42, the internal specular reflections that manifest as a gray or foggy appearance on typical combination TTP/LCD devices is reduced and ideally eliminated.

Another benefit associated with the display stack shown in FIG. 4 is attributable to removal of the polarizer over the LCD 52. As discussed above, a polarizer on the top surface of the LCD is necessary in most applications to make the LCD viewable. Also, as discussed above, in order to reduce reflection problems in the TTP 40, a polarizer is used at or near the outer surface, that is, between the viewer and the transparent electrodes and other optical components. However, these polarizers reduce the amount of light transmitted through the LCD by more than 10 percent for each polarizer. Thus, the use of these three polarizers may reduce the transmittance by 30% or more. Thus, while the front polarizer 42 reduces the problem of internal reflection in the TTP, it contributes to the problem of transmittance loss. Therefore, by removing the polarizer from the top of the liquid crystal cell 52 effectively replacing it with polarizer 42, transmittance will be increased and internal reflections will be reduced. It was also discovered by the inventor of the invention that by forming the second quarter wave plate 51 on the top of the liquid crystal cell 52 rather than on the bottom of the TTP 40, the resulting contrast ratio was up to 10 percent greater.

A further benefit accruing from the display stack described herein is that the image will appear in the plane of the front polarizer applied to the TTP. This presents a considerable advantage for systems employing deep mounting bezels because screen content near to the edge of the active area remains fully visible over wider viewing angles with a reduces bevel on the bezel.

In order to test the performance of the display stack according to the various embodiments of the invention, a LM-33-52 Contrast Measurement System from Hoffman Engineering of 8 Riverbend Drive, Stamford, Conn. 06907 and a TOPCON BM7 luminance calorimeter from TOPCON Industrial Products of 37 West Century Road, Paramus, N.J. 07652 were used. Measurements were made for Dark Luminance and dark-ambient contrast ratio, specular reflection as required by military specification MIL-L-85762A for daylight readable displays, diffuse reflection, and high luminance contrast ratio for devices incorporating nine different display stacks, two of which were based on the stack according to the various embodiments of the disclosure. Test results were obtained for two devices incorporating a display stack according to embodiments of the present disclosure as well as for seven other displays of varying luminance levels based on the prior art displays stacks, such as, for example, the stack shown in FIG. 3.

Table 1.1 below shows the experimental results for display luminance and dark ambient contrast ratio. This test was performed with the photometer located on a line perpendicular to the plane of the display, focused on the center of the screen.

TABLE 1.1

| Display | White | White | Black | Black | Dark Ambient |
|---|---|---|---|---|---|
| Number | Luminance (fL) | Luminance (nits) | Luminance (fL) | Luminance (nit) | Contrast Ratio |
| 1 | 129.3 | 443.0 | 0.45 | 1.54 | 287 |
| (battery) | | | | | |
| 2 | 91.25 | 312.6 | 0.59 | 2.202 | 155 |
| | | Other Displays | | | |
| 3 | 114.4 | 391.9 | 1.4 | 4.8 | 82 |
| 4 | 84 | 287.8 | 0.27 | 0.92 | 311 |
| 5 | 112 | 383.7 | 1.41 | 4.83 | 79 |
| 6 | 301.6 | 1033.2 | 0.85 | 2.91 | 355 |
| 7 | 106.7 | 365.5 | 0.53 | 1.82 | 201 |
| 8 | 145 | 496.7 | 0.529 | 1.81 | 274 |

As seen from the results in Table 1.1, the first two displays (#1 and #2) based on the display stack according to the various embodiments of this disclosure had a luminance level of half or less than that of the highest luminance display (6) and comparable to the next highest (8) but achieved comparable results for dark ambient contrast ratios. The number (6) achieved the highest dark ambient contrast ratio but with a luminance level of 1033.2 nits. The second best, the number 4 display, achieved a dark ambient contrast ratio of 311 but with nearly one quarter the luminance (287.8) of the number 6 display. Thus, the marginal increase in dark ambient contrast ratio was not justified by the significant increase in power required to output 1033.2 nits.

Table 1.2 below shows the results from measurement of measured using the Hoffman LM33-52 system in accordance with MIL-L-85762A, FIG. 4. To simulate a daytime sky, a uniform diffuse source was adjusted to deliver 2000fL at 30° with respect to the display axis. See the results below:

TABLE 1.2

| Display | Dark | Illuminated | Specular |
|---|---|---|---|
| Number | Luminance (fL) | Reflection (fL) | Reflection |
| 1 | 0.18 | 20 | 1.0% |
| 2 | 0.14 | 17.6 | 0.9% |
| 3 | 0.13 | 56.6 | 2.8% |
| 4 | 0.15 | 77 | 3.9% |
| 5 | 0.15 | 51.5 | 2.6% |
| 6 | 0.17 | 72.4 | 3.6% |
| 7 | 0.15 | 94.1 | 4.7% |
| 8 | 0.18 | 19.7 | 1.0% |
| 9 | 0.17 | 138.6 | 7.0% |

The experiment results in Table 1.2 show that the displays 1 and 2 according to the various embodiments of the disclosure performed significantly better than all the other displays except for number 8. Lower specular reflection signifies performance improvement without power penalty because reflected light from (for example) the sky represents a fixed luminance from the display screen, to which are added the (modulated) visual information. The greater the fixed component attributable to reflection, the less significant is the modulated light transmitted through the display, leading to reduced visibility of the displayed information. It is impossible to avoid the impact of specularly reflected light derived from the sky because it is not possible to move to a position where this is not visible. Thus, all other factors being equal, a display with a relatively lower percentage of specular reflection is easier to view than one with a relatively higher percentage of specular reflection.

Table 1.3 below shows the results for diffuse reflection for the same displays as Table 1.2.

TABLE 1.3

| White Screen | | | | Dark Screen | | | |
|---|---|---|---|---|---|---|---|
| | Dark | Illuminated | On Screen | Dark | | Off Screen | ON/OFF |
| Display | Luminance | Reflection | Diffuse | Luminance | Illuminated | Diffuse | Reflectance |
| Number | (fL) | (fL) | Reflectance | (fL) | Reflectance | Reflectance | Ratio |
| 1 | 2.7 | 32.4 | 1.4% | 0.22 | 4.2 | 0.2% | 7:1 |
| 2 | 0.15 | 24.4 | 0.4% | 0.16 | 3.68 | 0.1% | 4:1 |
| 3 | 0.16 | 30.7 | 0.5% | 0.15 | 16.5 | 0.3% | 1.7:1 |
| 4 | 0.15 | 163.8 | 2.6% | 0.16 | 141.4 | 2.3% | 1.1:1 |
| 5 | 0.15 | 28.8 | 0.5% | 0.15 | 16.26 | 0.3% | 1.7:1 |
| 6 | 1.3 | 47.3 | 2.2% | 0.18 | 27 | 1.3% | 1.7:1 |
| 7 | 0.16 | 54.9 | 2.6% | 0.16 | 44 | 2.1% | 1.2:1 |
| 8 | 0.16 | 28.8 | 1.3% | 0.17 | 16.1 | 0.7% | 1.9:1 |
| 9 | 1.1 | 68.1 | 3.1% | 0.17 | 45.3 | 2.1% | 1.5:1 |

These results show at least two things. While it is generally desirable to have low levels of diffuse reflectance, the high ON/OFF diffuse reflectance ratio indicates that the display can modulate the incident illumination. This increases image quality in sunlight operating conditions with no increase in power consumption. This is believed to be attributable to the specific ordering of the integrated device layers. Specifically, adhering the one quarter wave plate to the top of the LCD, rather than below the touch panel, while technically in the same order, produced less desirable results.

Finally, Table 1.4 shows the measured contrast ratios for eight of the nine test displays measured at 30° from the normal horizontal axis and on the vertical axis, per MIL-L-85762A, FIG. 4. See the results below:

TABLE 1.4

| Display | White Screen | Black Screen | Collimated | Diffuse | Contrast |
|---|---|---|---|---|---|
| Number | (fL) | (fL) | Illumination (fC) | Illumination (fL) | Ratio |
| 1 | 230 | 61.48 | 10,360 | 1974 | 3.7:1 |
| 2 | 90.8 | 28 | 10,000 | 1974 | 3.2:1 |
| 3 | 262 | 174 | 10,250 | 1974 | 1.5:1 |
| 4 | 438 | 364 | 10,000 | 1974 | 1.2:1 |
| 6 | 401.5 | 229 | 10,000 | 1974 | 1.8:1 |
| 8 | 249 | 122 | 10,000 | 1974 | 2.0 |
| 9 | 386 | 304 | 7,436 | 1974 | 1.3 |

Experimental data presented here shows that the two displays modified according to the various embodiments of this disclosure achieved superior measured contrast ratios of 3:7 and 3:2 to 1. According to military specification, Navy MIL-L-85762A, Table 1.2, the measured contrast ratio must exceed 3:1 to be considered daylight readable. Non-modified displays failed to achieve these levels and cannot be considered sunlight reading compatible. These data indicate that whilst use of increased luminance to provide enhanced sunlight visibility performance is a valid tool, it delivers inferior results in battery powered portable display applications used for comparison here. The embodiments of this disclosure present means of engineering significant gains in reflectance characteristics and transmission efficiency that improve sunlight illumination contrast ratio performance.

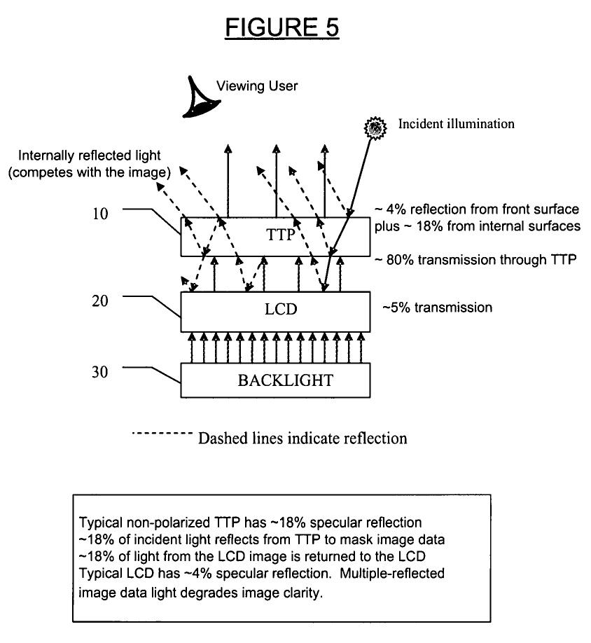

Referring now to FIG. 5, this Figures is a block diagram illustrating internal reflectance in an conventional integrated transparent touch panel liquid crystal display apparatus. As seen in the Figure, light comes from two sources, ambient illumination and the backlight. Ambient light is incident on the outer surface of the TTP 10. This light may be reflected at the outer surface, reflected in or at the back of the TTP or reflected at the LCD. In a typical non-polarized TTP, approximately 18% of the ambient light is subject to specular reflection. This reflected light obscures the display image. Also, light from the backlight 30 passes through the LCD 20. Some of this light exits the touch panel as the displayed image, while a portion of it is lost to internal reflection in the TTP 10. This causes multiple reflected image data which degrades clarity of the displayed image. Approximately 18% of the light passing through the LCD 20 is returned to the LCD 20 through internal reflections.

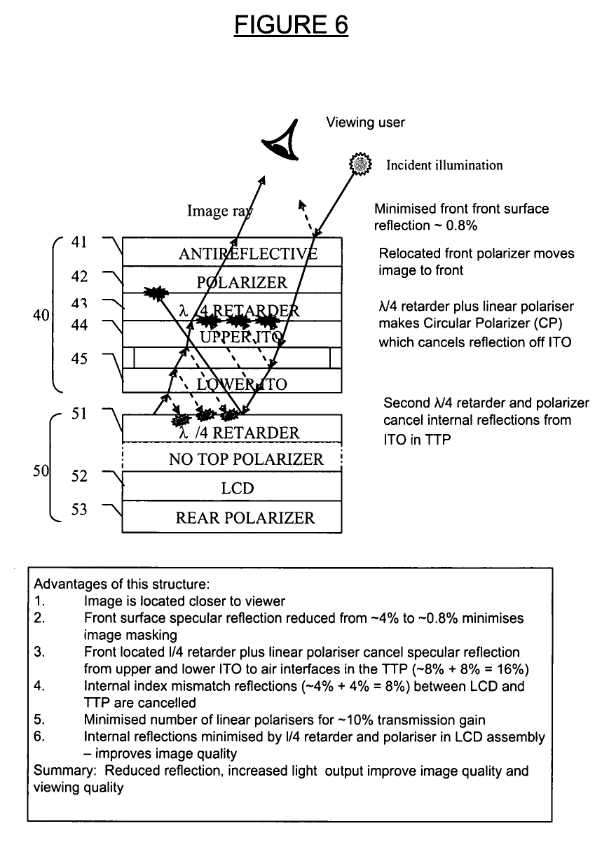

FIG. 6 is a block diagram illustrating internal reflectance in an integrated transparent touch panel liquid crystal display apparatus according to at least one embodiment of the disclosure. In this apparatus, front surface reflections are minimized by using an antireflective coating or layer. Light entering the TTP 40 that is reflected off the ITO layers 44, 45 of the TTP 40 is cancelled by the circular polarizer formed by the combination of the upper polarizer 43 and the quarter wave plate 43. Also, internally reflected light passing through the liquid crystal device 50 that reflects back due to refractive index mismatch with layers in the TTP 40 are cancelled by the quarter wave plate 51 on top of the liquid crystal device 50. One advantage of this TTP 40 and LCD 50 stack shown in FIG. 6 is that by the absence of the top polarizer on the LCD, the image is located optically closer to the viewer. Another advantage is that the front surfaced specular reflection is reduced from about 4% to 0.8% by the antiflective layer. Also, the circular polarizer comprising layers 42 and 43 cancel specular reflection from the upper and lower ITO layers of the TIP to air interfaces in the TTP. Also, by having the second wave plate 51 above the LCD 52, internal index mismatch-based reflections between the LCD 50 and TTP 40 are cancelled. By reducing the number of polarizers, that is removing the upper polarizer from the liquid crystal apparatus 50, approximately a 10% transmission gain is achieved. The net result is that reflection is reduced, light output is increased, and the image and viewing quality are improved without increasing heat generated, increasing luminance, or consuming more power.

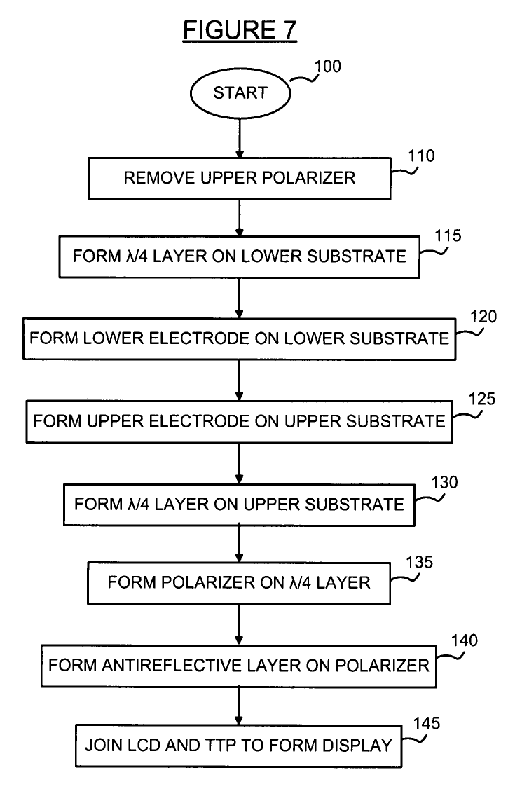

Referring now to FIG. 7, this Figure is a flow chart of an exemplary method of manufacturing an integrated transparent touch panel liquid crystal display device according to at least one embodiment of the invention. The method begins in block 100 and proceeds to block 110 where the upper polarizer layer is removed. As discussed herein, when an original equipment manufacturer (OEM) purchases LCD displays to incorporate in a consumer level product, the LCD display will usually include a top polarizer layer because this layer is required to view images displayed on the display. However, it should be appreciated that the operations of block 110 may be unnecessary if the liquid crystal device is manufactured without an upper polarizer, although, this is uncommon because this makes the display impossible to view alone. In block 115, a one quarter wave plate is formed on the top side of the liquid crystal display apparatus, at the position where the top polarizer was previously located. The quarter wave plate may be a film or other sheet. This completes the formation of the liquid crystal display component of the integrated device according to the various embodiments of this disclosure.

In block 120, the lower electrode of the transparent touch panel is formed on a lower, rigid-substrate. This may comprise forming a thin film of a transparent electrode such as indium tin oxide (ITO) on a substrate such as glass, plastic, resin, PET, etc. The lower electrode may be formed using deposition techniques such as electron beam evaporation, physical vapor deposition, or a range of different sputter deposition techniques.

In block 125, the upper electrode is formed on an upper substrate. In various embodiments, this may involve a process similar or identical to that performed in block 120 on a flexible upper substrate. This may also comprise positioning the upper substrate over the lower substrate so that the electrodes are facing one another with a small space in between, determined by a series of deformable transparent spacers. The space is closed when pressure is applied to the top of the upper substrate by the operator, causing the two facing transparent electrodes to touch.

In block 130 a one quarter wave plate is formed on the top side of the upper flexible substrate of the TTP. This may comprise layering a quarter wave film or equivalent. In block 135 a second polarizer is formed on the surface of the quarter wave plate. In various embodiments, this polarizer is oriented specifically to provide a complimentary match to the bottom polarizer of the LCD. In block 140, an antireflective layer is formed on the polarizer. The antireflective layer 140 may be a deposited film, coated glass, coated plastic, or equivalent, for example, it may be made of polyethylene terephthalate (PET).

The method stops after block 145, where the liquid crystal apparatus and the transparent touch panel (TTP) are joined to form an integrated LCD TTP display device. As discussed herein, the two components are oriented over one another with a space in between. Also, it should be appreciated that the various actions performed in blocks 110, 115, 120, 125, 130, 135, 140 and 145 may be performed in different orders than shown in the example of FIG. 5. For example, the TTP may be manufactured first or in parallel to the LCD. Also, a single manufacturer may perform all the actions or an OEM may assemble the integrated device from TTP and LCD components manufactured by one or more other manufacturers.

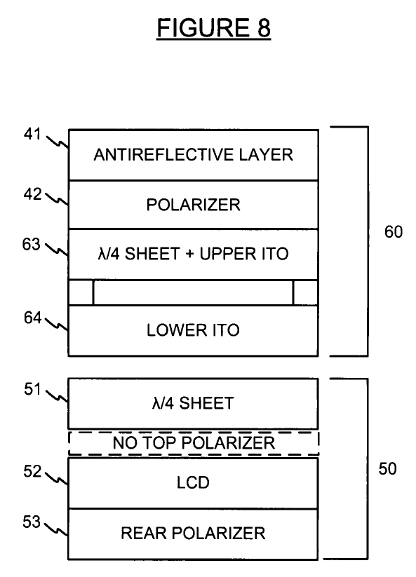

Referring now to FIG. 8, this Figure is a block diagram of an integrated transparent touch panel liquid crystal display apparatus according to at least one other embodiment of the disclosure. The embodiment illustrated in FIG. 8 differs from that of FIG. 4 in that the TTP 60 includes a quarter wave sheet and upper ITO layer as a single element 63. For example, instead of forming the ITO layer for the upper electrode on a glass substrate such as in the embodiment of FIG. 4, the ITO layer may be formed directly on the quarter wave sheet/plate to create an integrated layer 63. The liquid crystal apparatus 50 is unchanged from the embodiment of FIG. 4. Such an embodiment will still retain the properties discussed in the context of FIG. 6.

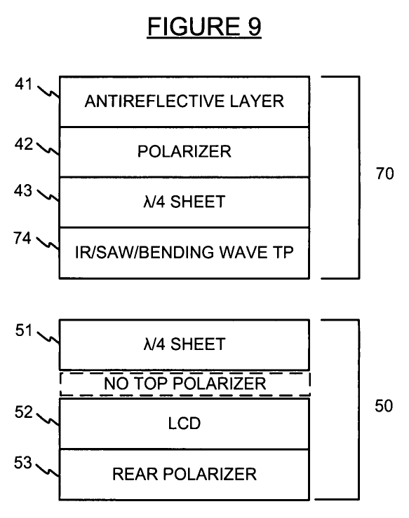

Referring now to FIG. 9, this Figure is a block diagram of an integrated transparent touch panel liquid crystal display apparatus according to at least one additional embodiment of the disclosure. In the embodiment illustrated in FIG. 9, the TTP 70 includes a type of touch panel 74 based on infra red, standing acoustic waves or bending wave technology. Such touch panel typically project wave or infrared light in a grid-like pattern across a substrate, such as a piece of glass or optically isotropic plastic. Touch points are registered by interruptions in the waves. In an integrated device employing such a touch panel technology, the principles and properties discussed in the context of FIG. 6 will still apply. That is, internal reflections will be reduced and ideally eliminated and viewability will be improved.

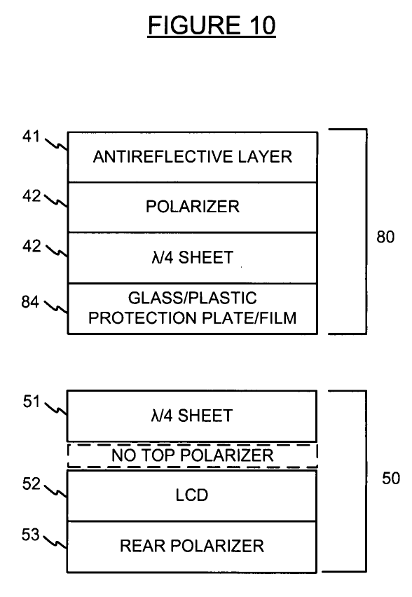

Referring now to FIG. 10, this Figure is a block diagram of a liquid crystal display apparatus according to at least one embodiment of the disclosure. Although in some embodiments, the improved display stack disclosed herein is for use with integrated resistive or capacitive transparent touch panel (TTP) and liquid crystal display (LCD) devices, the optical stack is also achieves performance improvements in applications where no TTP is included, that is, where a clear glass or plastic plate is placed over the display device. This may be particularly useful in applications that require an LCD type display to be used in bright ambient light conditions.

The display stack of FIG. 10 includes an outer portion 80 comprising the antireflective layer 41, first polarizer 42 and quarter wave sheet 43, in that order, mounted on a glass or plastic protective plate/film 84 such as optically anisotropic glass or plastic. This portion 80 is mounted over the liquid crystal apparatus 50 in manner analogous to the TTP 40 of FIG. 4. That is, the outer portion 80 may be mounted over the apparatus 50 with a gap between the outer portion 80 and the apparatus 50, or the outer portion 80 may be affixed directly to the quarter wave sheet 51 of the apparatus 50. It may be preferred that an air gap is provided between the outer portion 80 and the apparatus 50 so that if the outer portion gets damages, it can be replaced without scrapping the display apparatus 50. However, optical bonding may be employed to joint the outer portion 80 to the display apparatus 50. In such embodiments that do not include a TTP, reflection of ambient light will be prevented and internal reflections reduced and ideally eliminated by the application of the same principles discussed in the context of FIG. 6, thereby enhancing the viewability of the display device incorporating the apparatus 50 and outer portion 80.

The embodiments of the present inventions are not to be limited in scope by the specific embodiments described herein. For example, although many of the embodiments disclosed herein have been described in the context of an integrated resistive transparent touch panel liquid crystal display device and methods of manufacturing such a device, other embodiments, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Many modifications to the embodiments described above can be made without departing from the spirit and scope of the invention. Accordingly, the claims set forth below should be construed in view of the full breath and spirit of the embodiments of the present inventions as disclosed herein. Also, while the foregoing description includes many details and specificities, it is to be understood that these have been included for purposes of explanation only, and are not to be interpreted as limitations of the present invention.

1. A display device comprising:
a touch panel display comprising a lower transparent electrode formed on a first transparent layer, an upper transparent electrode formed on a second transparent layer, the upper and lower transparent electrodes facing each other with a space in between, a first quarter wavelength layer formed on a top surface of the second transparent layer, a first single linear polarizing film on the first quarter wavelength layer, and an antireflective layer on the first single polarizer layer; and
a liquid crystal apparatus comprising a rear positioned linear polarizing film affixed to a liquid crystal cell, and a second quarter wavelength layer formed directly on the top surface of the liquid crystal cell, wherein the touch panel display is mounted on the liquid crystal apparatus to form an integrated display device, and the liquid crystal apparatus is characterized in that the first linear polarizing film of the touch panel display and the rear positioned linear polarizing film are oriented such that the axes of polarization are compatible, and there is no upper polarizing film on the liquid crystal apparatus.

2. The device according to claim 1, wherein the liquid crystal apparatus includes a light source beneath the second single linear polarizing film causing visible light to be emitted by the display device.

3. The device according to claim 1, wherein the liquid crystal apparatus is characterized in that light emitted by the device is not visible until the touch panel display is mounted on the liquid crystal apparatus.

4. The device according to claim 1, wherein the antireflective layer comprises a polyethylene terephthalate (PET) layer or equivalent.

5. A computing device incorporating a display device according to claim 1.

6. The apparatus according to claim 5, wherein the computing device is a computing device selected from the group consisting of a laptop computer, a tablet computer, and a handheld computer.

7. A method of manufacturing an integrated transparent touch panel liquid crystal display device comprising:
forming a liquid crystal display apparatus comprising a liquid crystal cell having a first polarizing film formed on a lower surface, and a first quarter wavelength sheet formed on an upper surface thereof;
forming a transparent touch panel comprising forming a lower transparent electrode on an upper surface of a lower glass substrate, forming an upper transparent electrode on a lower surface of an upper glass substrate, forming a second quarter wavelength film on an upper surface of the upper glass substrate, forming a single polarizing film on the one quarter wavelength sheet, forming an antireflective layer on the single polarizing film; and
joining the liquid crystal display apparatus with the transparent touch panel to form an integrated device so that the first quarter wavelength sheet of the liquid crystal display device faces the lower glass substrate of the transparent touch panel.

8. The method according to claim 7, further comprising forming a light source under the liquid crystal display apparatus that causes visible light to be emitted by the integrated device.

9. The method according to claim 7, wherein forming an antireflective layer comprises forming a polyethylene terephthalate (PET) or equivalent layer.

10. A method of manufacturing a combination touch panel liquid crystal display device having enhanced brightness and contrast comprising:
forming a liquid crystal display apparatus by:
forming a first polarizing film on a bottom side a liquid crystal cell;
removing a front polarizing film from a top side of the liquid crystal cell; and
forming a first quarter wavelength sheet on the top side of the liquid crystal cell;
forming a transparent touch panel apparatus by:
forming a first transparent electrode on a top surface of a lower substrate;
forming a second transparent electrode on a bottom surface of an upper substrate;
positioning the second transparent electrode over the first transparent electrode with a space in between;
forming a second one quarter wavelength sheet on a top surface of the upper substrate;
forming a second single linear polarizing film on the second one quarter wavelength sheet; and
forming an antireflective layer on the second single linear polarizing film; and
joining the liquid crystal display device to the transparent touch panel apparatus to produce an integrated device such that the first one quarter wavelength sheet faces a bottom surface of the lower substrate.

11. The method according to claim 10, wherein forming an antireflective layer comprises forming a polyethylene terephthalate (PET) or equivalent layer.

12. The method according to claim 10, further comprising placing a light source under the liquid crystal display apparatus, the light source causing visible light to be emitted by the integrated device.

13. The method according to claim 10, wherein removing a front polarizing film from a top side of the liquid crystal cell comprises removing a polarizing layer integral to the liquid crystal cell, thereby rendering light emitted by the liquid crystal display apparatus invisible until the liquid crystal display apparatus is joined with the transparent touch panel apparatus.

14. A display device comprising:
an outer portion comprising:
an antireflective layer;
a first polarizer;
a first quarter wave sheet; and
a protective layer, formed in that order; and
a display portion comprising:
a second quarter wave sheet,
a liquid crystal cell; and
a second polarizer, formed in that order;
wherein, the outer portion is mounted over the display portion to create a display device and the first polarizer and second polarizer are oriented such that the axes of polarization are compatible.
